(19) United States
(12) Patent Application Publication
(10) Pub. No.: US 2002/0151825 A1
(43) Pub. Date: Oct. 17, 2002

(54) Ultrasound plaque emulsion device

(75) Inventors: Alexander M. Rubenchik, Livermore, CA (US); Paul J. Weber, Ft. Lauderdale, FL (US); Luiz B. Da Silva, Danville, CA (US)

Correspondence Address: John P. Wooldridge, 1334 Ridgestone Court, Livermore, CA, 94550, US

(73) Assignee: Pearl Technology Holdings, LLC

(21) Appl. No.: 09/834,554

(22) Filed: Apr. 12, 2001

(51) Int. Cl. A61H 1/00

(52) U.S. Cl. 601/2

(57) ABSTRACT

A medical device is described that can be used to emulsify and remove atherosclerotic plaque from blood vessels. The device uses a high frequency ultrasound transducer and conical tip to enhance the generation of shear waves that can safely and efficiently emulsify plaque.

### BACKGROUND OF THE INVENTION

1. Field of the Invention

The present invention relates to a medical device in general, and in particular to atherectomy devices that emulsify and remove atherosclerotic plaque from blood vessels. The present invention also relates to an ultrasound device to enhance drug delivery to blood vessels.

2. Description of Related Art

An estimated seven million Americans suffer from coronary artery disease, which causes 1.5 million myocardial infarctions (heart attacks) and over half a million deaths annually at a cost of over $100 billion. Coronary artery disease results from atherosclerosis, a complex process in which fatty and other deposits (i.e., cellular intimal and mineral, i.e., calcium additives, and engrained proteinaceous or clotting/platelet debris) build up on the walls of arteries, resulting in blockages and reduced blood flow. This process leads to the formation of a plaque of atherosclerotic material that can be comprised of various cells, lipids (fats or cholesterol), and collagen (fibrous tissue). This process progresses over a number of years and may eventually result in the formation of a blockage (stenosis) in the coronary artery. If the artery is sufficiently narrowed, blood flow is reduced (ischemia), and chest pain (angina pectoris), heart attack, or sudden death may follow. In addition to the fixed narrowing produced by atherosclerosis, plaques may also rupture, resulting in the formation of a thrombus (clot) on the plaque surface, leading to an abrupt cessation of blood flow to the heart Plaque rupture plays a key role in most cases of heart attack and stroke.

In 1977, Dr. Andreas Gruentzig from Switzerland introduced a novel method for treating coronary artery stenosis, which he termed Percutaneous Transluminal Coronary Angioplasty (PTCA) also commonly known as balloon angioplasty. Over 500,000 coronary angioplasties (the term angioplasty is derived from angio, which refers to a blood vessel, and plasty, which means to reshape) were performed in the U.S., surpassing the number of coronary bypass operations. The advantage of this technique is that it can be performed using minimally invasive catheter procedures. Using special x-ray equipment and contrast dye to visualize the arteries, the cardiologist advances a guide catheter (hollow tube) through the sheath and up the aorta to the origin of the coronary arteries. Using this catheter as a track to the coronary artery, a long, fine guidewire (generally 0.014 inches in diameter) is negotiated across the stenosis. A catheter with a deflated balloon on the far end is then advanced over the guidewire to the narrowed arterial segment At this point the balloon in inflated and the occluding plaque compressed to the arterial wall.

In conventional PICA the occluding plaque is simply compressed and no material is removed. In about one-third of cases, re-narrowing of the treated segment may occur over a period of several months, necessitating a repeat procedure or coronary artery bypass surgery. This re-narrowing is termed restenosis and appears to be distinct from the process of atherosclerosis. Despite intense research efforts and numerous drug trials, a solution to this problem remains elusive.

In an attempt to overcome some of the limitations of angioplasty, alternative procedures to relieve coronary obstructions have been introduced which cut away plaque material to open up the artery (atherectomy). There are three main types of atherectomy devices. The first device and procedure was developed in 1985 by Dr. Simpson and called Directional Coronary Atherectomy (DCA). This device is advanced through a guide catheter over a guidewire to the diseased coronary arterial segment in a fashion similar to standard balloon catheters. The cutting device, a small circular cutting blade, is encased in a metal housing with an opening on one side and a small balloon on the opposite side. By inflating the balloon, the cutter is pushed up against the atherosclerotic plaque; then, with a battery-operated motor, the cutting blade is rotated at 2000 rpm Any plaque matter that projects through the window into the housing is trimmed off. The problem with this device is that it needs to be deployed multiple times and can damage artery wall that is drawn within the housing.

The Transluminal Extraction-endarterectomy Catheter (TEC) is an atherectomy device designed by InterVentional Technologies Inc. (San Diego, Calif.) and developed by Dr. Richard Stack at Duke University Medical Center in North Carolina. This instrument consists of two stainless steel blades at the conical head of a catheter. After being advanced to the diseased arterial segment over a guidewire, the blades rotate at 750 rpm. The rotating head trims plaque away from the arterial lumen (channel), and the plaque fragments are suctioned out through the catheter into a collecting bottle. This device is more effective with soft plaque.

Another atherectomy device, the Rotablator (U.S. Pat. Nos. 4,990,134 and 6,113,615), consists of a brass burr coated with small diamond chips welded to a flexible drive shaft The rotablator device moves over a guidewire to the desired location in the coronary artery. Using a compressed air-powered turbine, the drive shaft and brass burr rotate at 180,000 rpm The rotating head pulverizes the plaque into minute particles. The Rotablator appears to be effective for treating hard calcified and eccentric lesions. However, the high rotation speed necessary to effectively emulsify plaque increases the risk of perforating the artery wall. In addition, frictional heating can thermally damage the artery leading to complications.

Given the limitations of current atherectomy devices, there is a need for a novel atherectomy device that can safely and effectively emulsify soft and hard atherosclerotic plaque. The present invention fulfills this need, and further provides related advantages.

### SUMMARY OF THE INVENTION

An object of the present invention is to provide an atherectomy device that can be inserted through a catheter to emulsify atherosclerotic plaque or thrombus in blood vessels. The device uses high frequency ultrasound generated by a piezoelectric transducer coupled to a conical shaped tip to safely emulsify plaque while minimizing the risk of damaging the arterial wall.

In normal use, a physician threads the device over a guidewire and into a catheter and then pushes the device until the distal tip reaches the occluded region of the artery. When the device touches the plaque, the ultrasound transducer is activated and the device gently pushed as it emulsifies the plaque. Ultrasound generated by the transducer propagates into and through a conical tip that is bonded to one side of the transducer. The longitudinal planar ultrasound waves that are generated by the transducer propagate to the angled surface of the conical tip and are partly converted to shear waves that travel along the angled surface. The combination of transmitted longitudinal ultrasound and shear waves along the transducer surface act to efficiently tear and emulsify plaque. The thickness of the interaction layer is controlled by the frequency of the ultrasound used. For very thin (˜100 to 200 micron) layers, high frequency ultrasound is used 50-200 MHz. The short wavelength of ultrasound helps to emulsify the plaque into very small particles. As the plaque is emulsified, the device moves forward through the plaque. The surgeon applies minimal force to the external end of the device to maintain the device in contact with untreated plaque. The surgeon can perform this procedure under x-ray imaging (or ultrasound, MRI) to guide therapy and determine when the device has moved through the occlusion. In addition, the surgeon will feel a change in the resistance to forward motion of the device that can be used to determine the end of the procedure. The device can be manufactured in a range of diameters (1 mm to 10 mm) suitable for treating most arteries in the human body.

The proximal end of the device has a handle with a central lumen and a cable that connects to the electronic control unit. The electronic control unit is used to control the ultrasound power and frequency. The electronic control unit can include sensors that detect what type of device (i.e., size etc.) has been connected.

The use of high frequency ultrasound makes this device safe and effective on both soft and hard plaque. This device could also be used to treat in-stent restenosis. In addition, the present device could be used to enhance drug delivery to the artery wall during the procedure by injecting drugs through the catheter to the area of treatment. This could be an important application as new pharmaceuticals are being developed that have the potential of reducing the restenosis rate after atherectomy. The use of ultrasound to enhanced drug delivery has been proven and is widely accepted.

These and other objects will be apparent to those skilled in the art based on the teachings herein. Other objects and advantages of the present invention will become apparent from the following description and accompanying drawings.

### BRIEF DESCRIPTION OF THE DRAWINGS

The accompanying drawings, which are incorporated into and form part of this disclosure, illustrate embodiments of the invention and together with the description, serve to explain the principles of the invention.

FIG. 1 is an illustration of how the ultrasound atherectomy device is used.

FIG. 2 shows a sectional view of the distal end of one embodiment of the ultrasound atherectomy device.

FIG. 3 shows a sectional view of the distal end of an alternative embodiment of the ultrasound atherectomy device.

FIG. 4A shows a sectional view of the distal end of an alternative embodiment of the ultrasound atherectomy device that is asymmetrical to produce larger lumen.

FIG. 4B shows an end view of the device shown in FIG. 4A.

FIG. 5 is a schematic showing an alternative embodiment of the ultrasound atherectomy device that includes centering wires.

FIG. 6 is a schematic showing the components of one possible embodiment of the ultrasound atherectomy system.

### DETAILED DESCRIPTION OF THE INVENTION

The invention is an atherectomy device that can be inserted through a catheter to emulsify atherosclerotic plaque or thrombus in blood vessels. The device uses high frequency ultrasound generated by a piezoelectric transducer coupled to a conical shaped tip to safely emulsify plaque while minimizing the risk of damaging the arterial wall.

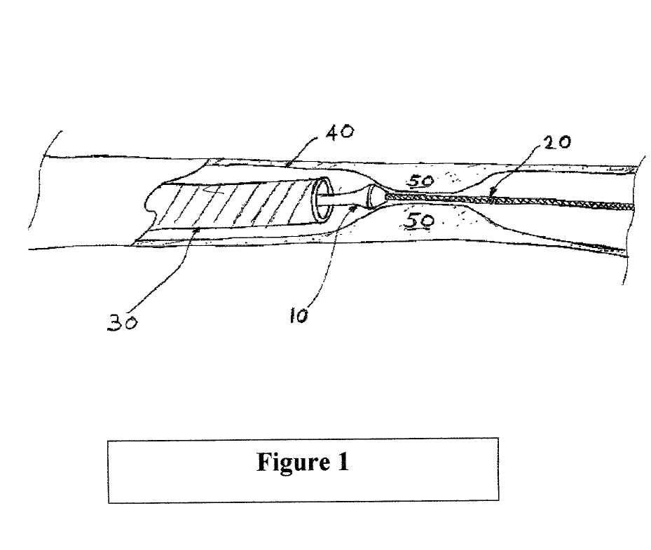

FIG. 1 is an illustration showing how the ultrasound atherectomy device is used. The device 10 is guided to the treatment area by tracking over a guidewire 20 that has been previously inserted by the surgeon. In normal operation the device 10 is within a catheter 30 that provides additional guiding and protects the artery wall 40 as the device 10 is inserted. In normal use, the device 10 is moved into contact with the occluding plaque 50 and then the ultrasound transducer activated. The ultrasound propagates out of the shaped distal tip of the device and emulsifies plaque within a thin layer. The thickness of the interaction layer is controlled by the frequency of the ultrasound used. For very thin (100 to 200 micron) layers, high frequency ultrasound is used (50-200 MHz). The short wavelength of ultrasound helps to emulsify the plaque into very small particles, which will reduce the risk of arterial blockage downstream. As the plaque is emulsified, the device 10 moves forward through the plaque. The surgeon applies minimal force to the external end of the device to maintain the device in contact with untreated plaque. The surgeon can perform this procedure under x-ray imaging to guide therapy and determine when the device has moved through the occlusion. In addition, the surgeon will feel a change in the resistance to forward motion of device that can be used to determine the end of the procedure.

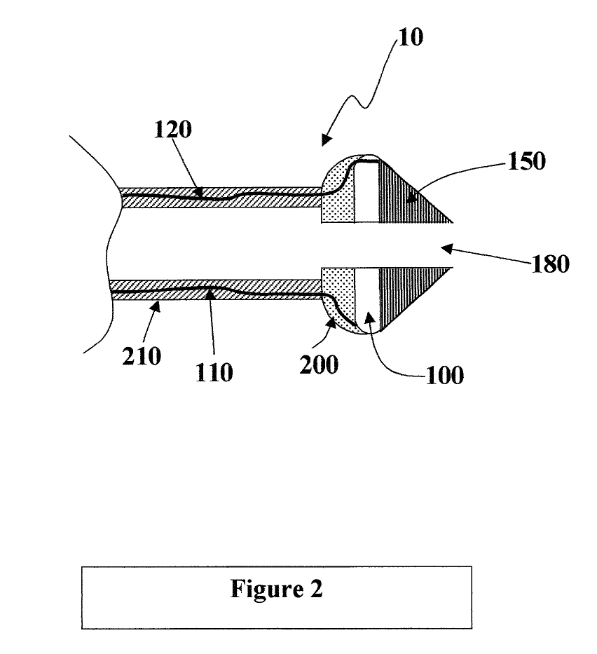

FIG. 2 shows a cross sectional view through one embodiment of the distal tip of the device 10. The device consists of a piezoelectric element 100 that generates continuous or pulsed ultrasound. The piezoelectric element can be made of any piezoelectric material such as PZT (lead zirconate titanate), PVDF (polyvinylidine difluoride), LiNb and quartz. The preferred material and thickness of the transducer depends on the desired operating frequency of the device. See “The Physics of Medical Imaging” Ed. Steve Webb (1988), and “Ultrasound in Medicine” Ed. F. A. Duck, A. C Baker, H. C. Starritt (1997). For example for a PZT transducer working at 100 MHz, the thickness of the PZT element is approximately 20 microns. Electrical leads 110 and 120 connect to the two faces of the piezoelectric element 100 and apply the driving voltage to the piezoelectric material to generate the ultrasound. The two faces of the piezoelectric element 100 have a conductive coating (typically silver) so that the voltage is applied uniformly across the two faces of the piezoelectric material.

A conical shaped segment 150 is bonded to the piezoelectric element 100 and used to guide the generated ultrasound energy to the angled surface. The longitudinal planar ultrasound waves that are generated by the piezoelectric element 100 propagate to the angled surface and are partly converted to shear waves at the interface. The optimum cone angle that enhances the conversion from compression waves to shear waves is between 60 to 120 degrees. The combination of transmitted longitudinal ultrasound and shear waves act to efficiently tear and emulsify plaque. To further enhance plaque emulsification, the outer surface of the shaped segment 150 can be roughened to increase friction. In addition, the outer surface of the shaped segment 150 can be corrugated with grooves that spiral inward. This breaking of axial symmetry will enhance the conversion of the ultrasound into shear and torsion waves. These waves are more effective then compression waves at breaking up thrombus and plaque, which are comprised of long fibrils. The device can in principle be any diameter, however, for use in arteries a range of device diameters will be available that will allow the surgeon to treat arteries ranging in size from 1 mm diameter to 10 mm diameter. The central lumen 180 allows the device to be threaded down a guidewire,

On the back surface, the ultrasound transducer 100 is bonded to a backing layer 200 that connects to the hollow cable 210. The material and thickness of the backing layer 200 are selected to optimize the ultrasound energy transmitted in the forward direction. For the desired operating frequencies (40-200 MHz) the backing layer 200 will be less than 3 mm thick and can be made of glass, metal, hard polymer (e.g., polyurethane, Teflon, high density polyethylene) or composites (e.g., graphite composite, epoxy resin and tungsten powder). The cable 210 contains the electrical leads 110 and 120 that drive the piezoelectric element 100 and has adequate stiffness to allow the physician to use it to push the device along the guidewire. The cable can be made of a variable thickness polymer tube or wire using techniques generally used to produce catheters or guidewires. The details of the cable, guidewire and catheters are well known to those of ordinary skill in the art and are therefore not discussed further.

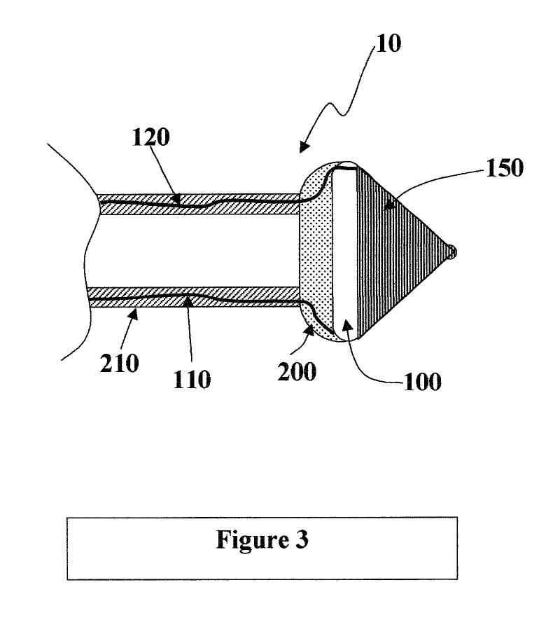

FIG. 3 shows a cross sectional view through an alternative embodiment of the distal tip of the device 10. In this case, the central lumen that is used to thread the guidewire has been eliminated. This embodiment allows the device to be used when a guidewire cannot be passed through the occlusion. Guidewire tracking is usually necessary to ensure that the treatment device does not accidentally push through the artery wall. The low risk of artery perforation using the present device makes doing the procedure without a guidewire possible.

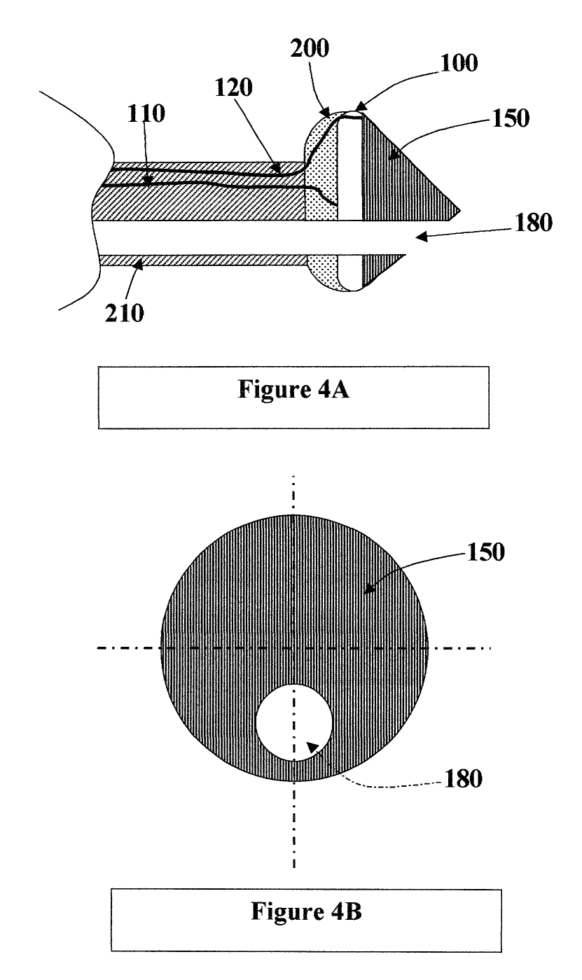

FIG. 4A and 4B show a cross sectional view and an end view of an alternative embodiment of the distal tip of the ultrasound device 10. In this case, the lumen 180 that is used to thread the guidewire is off center. With this embodiment, the surgeon can increase the treatment area by rotating the device around the guide wire. Applying torque to cable 210 outside the body performs device rotation. This embodiment is well suited to treating occlusions that are not axially symmetric.

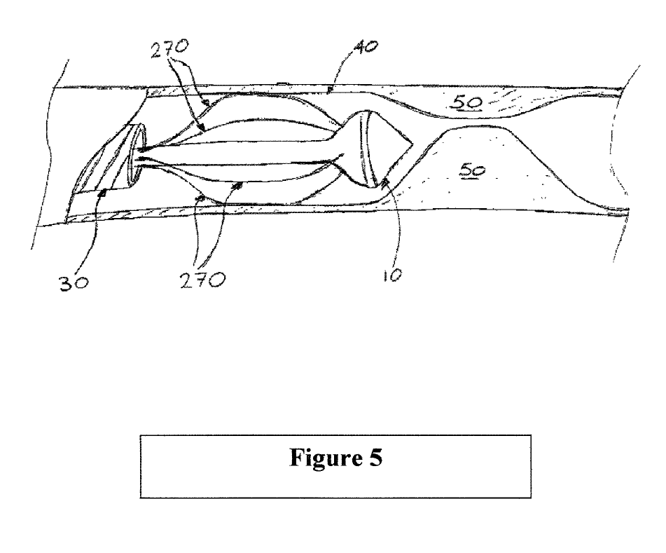

FIG. 5 shows a schematic illustration of an alternative embodiment of the device where centering wires 270 behind the ultrasound device 10 extend out to center the device within the lumen of the blood vessel. The centering wires deploy as the device 10 is pushed out of the catheter 30 and retract when the device 10 is pulled back into the catheter 30. The centering wires provide additional safety by reducing the chance of the device 10 perforating the blood vessel wall.

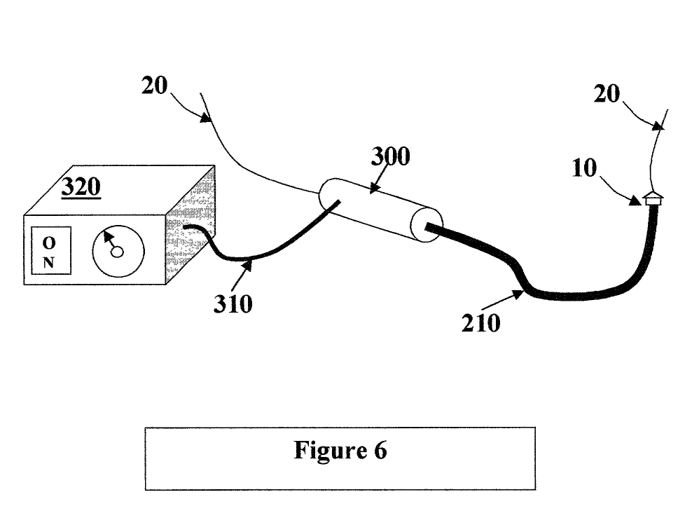

FIG. 6 shows a complete system, which includes the ultrasound transducer 10 and the cable 210 coupled to a handle 300 that the physician can use to push and manipulate the device 10. An electrical cable 310 exits the handle 300 and is used by the electronic control unit 320 to drive the piezoelectric element at the distal tip of the ultrasound transducer 10. The electronic control unit 320 allows the physician to control the amount of power applied to the device. In one embodiment, the electronic control unit 320 also allows the physician to select the operating frequency.

The ultrasound attenuation coefficient of human tissue scales approximately linearly with frequency. At high frequencies the attenuation coefficient is very high leading to short ultrasound propagation distances. For example, at 100 MHz the thickness over which the power is reduced to approximately 1/3 is 75 microns. This ensures that the ultrasound energy with the present devices does not affect tissue that is further than several hundred microns. The wavelength λ of high frequency ultrasound in tissue can be calculate from λ=c/f where c is the speed of sound in the tissue and f is the frequency. For human tissue, c˜1600 m/s for skin, 1400 m/s for fat, 1600 m/s for muscle, and 3500 m/s for bone. Therefore, at 100 MHz, the wavelength is 16 to 35 microns in tissue, which is only a few times larger than biological cells. Attenuation coefficients and sound speeds in tissue are known in the art See, e.g., “Ultrasound in Medicine” Ed. F. A. Duck, A. C. Baker, H. C. Starritt). The short wavelength improves the efficiency of generating small particles.

The above descriptions and illustrations are only by way of example and are not to be taken as limiting the invention in any manner. One skilled in the art can substitute known equivalents for the structures and means described. The full scope and definition of the invention, therefore, is set forth in the following claims.

1. An atherectomy device, comprising:
a device tip having a tip front face and a tip rear face;
a piezoelectric element (PZE) having a PZE front face and a PZE rear face, wherein said PZE front face is fixedly attached to said tip rear face;
means for energizing said PZE; and
a flexible shaft attached to said PZE for positioning said PZE to a position within the vasculature for removing arterial plaque.

2. The device of claim 1, wherein said device tip comprises a conical shape.

3. The device of claim 1, wherein said flexible shaft comprises a lumen for passage of a guidewire.

4. The device of claim 3, wherein said device tip comprises an opening for passage of said guidewire.

5. The device of claim 4, wherein said opening is centered on said device tip.

6. The device of claim 4, wherein said opening is off-enter of said device tip, wherein the area of said arterial plaque under treatment may be increased by rotating said device tip around said guide wire.

7. The device of claim 1, further comprising a backing layer having a backing layer front face and a backing layer rear face, wherein said backing layer front face is connected to said PZE rear face, wherein said backing layer rear face is connected to said flexible shaft.

8. The device of claim 1, wherein said means for energizing said PZE comprises a first electrical lead connected to said PZE front face and a second electrical lead connected to said PZE rear face and an electrical source operatively connected to said first electrical lead and said second electrical lead.

9. The device of claim 8, wherein said PZE front face comprises a conductive coating electrically connected to said first electrical lead.

10. The device of claim 8, wherein said PZE rear face comprises a conductive coating electrically connected to said second electrical lead.

11. The device of claim 8, wherein said PZE front face comprises a first conductive coating electrically connected to said first electrical lead, wherein said PZE rear face comprises a second conductive coating electrically connected to said second electrical lead.

12. The device of claim 1, wherein said first conductive coating and said second conductive coating comprise material selected from the group consisting of silver, gold and conductive epoxies.

13. The device of claim 1, wherein said PZE comprises piezoelectric material.

14. The device of claim 13, wherein said piezoelectric material is selected from the group consisting of lead zirconate titanate, polyvinylidine difluoride, LiNb, and quartz.

15. The device of claim 8, wherein said electrical source is configured to provide continuous energy to said PZE to produce continuous ultrasound from said PZE.

16. The device of claim 8, wherein said electrical source is configured to provide pulsed energy to said PZE to produce pulsed ultrasound from said PZE.

17. The device of claim 1, wherein said device tip comprises an angled surface having an angle selected to couple ultrasound energy into said plaque.

18. The device of claim 3, wherein said flexible shaft has adequate stiffness to allow a user to push said device tip along said guidewire.

19. The device of claim 1, wherein said PZE comprises a material and a thickness that are selected for a desired operating frequency of said PZE.

20. The device of claim 1, wherein said device tip is roughened to increase friction and enhance plaque emulsification.

21. The device of claim 1, wherein said tip front face is corrugated with grooves that spiral inward providing a breaking of axial symmetry that enhances conversion of ultrasound waves from said PZE into shear and torsion waves.

22. The device of claim 2, wherein said conical shape comprises an cone angle that is between 60 and 120 degrees with respect to said arterial plaque.

23. The device of claim 1, wherein said device tip comprises a diameter within a range from 1 mm to 10 mm.

24. The device of claim 7, wherein said backing layer comprises a material and thickness that are selected to optimize the ultrasound energy transmitted in the forward direction.

25. The device of claim 7, wherein said backing layer comprises material selected from the group consisting of glass, metal, hard polymer and composites (e.g., graphite composite, epoxy resin and tungsten powder).

26. The device of claim 25, wherein said hard polymer is selected from the group consisting of polyurethane and Teflon®.

27. The device of claim 25, wherein said composites are selected from the group consisting of graphite composite, epoxy resin and tungsten powder.

28. The device of claim 1, further comprising a catheter that sheaths said device tip.

29. The device of claim 28, wherein said device tip may be pushed out of said catheter.

30. The device of claim 29, further comprising centering wires operatively connected between said device tip and said flexible shaft, wherein said centering wires deploy as said device tip is pushed out of said catheter, wherein said centering wire retract when the device tip is pulled back into said catheter.

31. The device of claim 1, further comprising a handle connected to said flexible shaft to enable a user to manipulate said device tip.

32. The device of claim 1, wherein said means for energizing said PZE comprises an electronic control unit that controls said PZE.

33. The device of claim 32, wherein said control unit includes means for controlling at least one operating parameter of said PZE, wherein said operating parameter is selected from the group consisting of energy applied to said PZE and operating frequency of said PZE.

34. A method for performing atherectomy, comprising:
inserting an atherectomy device into the vasculature near arterial plaque, wherein said device comprises:
a tip having a tip front face and a tip rear face;
a piezoelectric element (PZE) having a PZE front face and a PZE rear face, wherein said PZE front face is fixedly attached to said tip rear face;
means for energizing said PZE; and
a flexible shaft attached to said PZE for positioning said PZE to a position within said vasculature for removing arterial plaque; and
energizing said PZE to produce ultrasound waves.
